(19) United States
(12) Patent Application Publication
(10) Pub. No.: US 2020/0411008 A1
(43) Pub. Date: Dec. 31, 2020

(54) VOICE CONTROL METHOD AND DEVICE

(71) Applicant: Beijing Bytedance Network Technology Co., Ltd., Beijing (CN)

(72) Inventors: Peng LI, Beijing (CN); Yonghao LUO, Beijing (CN)

(21) Appl. No.: 17/020,509

(22) Filed: Sep. 14, 2020

Related U.S. Application Data
(63) Continuation of application No. PCT/CN2019/085905, filed on May 7, 2019.

(30) Foreign Application Priority Data
May 14, 2018 (CN) 201810456387.X

(51) Int. Cl. G10L 15/26; G10L 15/22; G06F 3/16

(52) U.S. Cl. CPC G10L 15/26; G06F 3/167; G10L 15/22

(57) ABSTRACT

A voice control method and a voice control device are provided. The method includes: receiving voice data in response to a trigger operation for an interaction interface, the trigger operation being an operation that triggers voice control and that is recognized by a client on the interaction interface; converting the voice data into text data; generating a control instruction based on the text data; and executing the control instruction.

### CROSS REFERENCE TO RELATED APPLICATION

The present application is a continuation of International Patent Application No. PCT/CN2019/085905 filed on May 7, 2019 which claims priority to Chinese Patent Application No. 201810456387.X, filed on May 14, 2018 with the Chinese Patent Office, both of which are incorporated herein by reference in their entireties.

### TECHNICAL FIELD

This disclosure relates to the field of voice control technology, and in particular to a voice control method and a voice control device.

### BACKGROUND

With the development of technology, a way of interacting with applications on a smart terminal through voice is increasingly favored by users. However, there are still many problems to be solved about voice interaction.

### SUMMARY

In view of this, a voice control method and a voice control device are provided according to embodiments of the present disclosure, to improve the efficiency of voice interaction between a user and a smart terminal.

Following technical solutions are provided according to the embodiments of the present disclosure.

In a first aspect, a voice control method is provided according to an embodiment of the disclosure. The voice control method includes: receiving voice data in response to a trigger operation for an interaction interface; determining an action keyword based on the voice data; determining an object keyword based on the operation object of the trigger operation; generating a control instruction based on the action keyword and the object keyword, wherein the control instruction is used for controlling an operation object indicated by the object keyword.

In a second aspect, a voice control method is provided according to an embodiment of the disclosure. The voice control method includes: receiving voice data in response to a trigger operation for an interactive interface; determining an object keyword based on the voice data; determining an action keyword based on the object keyword; generating a control instruction based on the action keyword and the object keyword, wherein the control instruction is used to control an operation object indicated by the object keyword.

In a third aspect, a voice control device is provided according embodiments of the present disclosure. The device includes: one or more processors and a memory storing one or more programs. The one or more processors execute the one or more programs to perform operations. The operations include: receiving voice data in response to a trigger operation for an interaction interface; determining an action keyword based on the voice data; determine an object keyword based on the operation object of the trigger operation; generating a control instruction based on the action keyword and the object keyword, wherein the control instruction is used for controlling an operation object indicated by the object keyword.

In embodiments of the present application, it can be implemented that the voice data input by the user is received in the interaction interface, by receiving voice data in response to a trigger operation for an interactive interface. Further, determining an action keyword based on the received voice data may determine an action that the user wants to perform. In addition, an object that the user wants to operate may be determined, by determining an object keyword based on an operation object of the trigger operation. Further, combining voice data input by a user with a trigger operation executed by the user, a control instruction may be generated, by generating the control instruction based on the action keyword and the object keyword. Thus, the flexibility of generating the control instruction is improved. In practice, the control instruction is used to control the object indicated by the object keyword. Thus, the control of the object that the user wants to operate is realized, by combining the voice data input by the user and the executed trigger operation.

In some embodiments, in the process of voice interaction, the interaction interface does not need to be switched to the voice input interface. Therefore, the efficiency of the user to perform voice interaction can be improved.

### BRIEF DESCRIPTION OF THE DRAWINGS

FIG. 1 is a schematic diagram of an exemplary application scenario according to some embodiments of the disclosure;

FIG. 2 is a schematic flowchart of a voice control method according to some embodiments of the disclosure;

FIG. 3 is a schematic diagram of a software architecture of an exemplary application scenario according to some embodiments of the disclosure; and

FIG. 4 is a schematic structural diagram of a voice control device according to some embodiments of the disclosure.

### DETAILED DESCRIPTION OF THE EMBODIMENTS

A voice control method is provided according to the embodiments of the disclosure. In the voice control method, the trigger operation recognized by the client triggers the reception of the voice data, so that operations required to be performed by the user are reduced, thereby improving the efficiency of the interaction between the user and the client. Specifically, when the user needs to interact with the client on the terminal through voice control, the terminal may receive the voice data in response to the trigger operation for the interaction interface, where the trigger operation is an operation that triggers voice control and that is recognized by a client on the interaction interface. Then the terminal may convert the received voice data into text data, and generate the control instruction for operating the application based on the text data, and the terminal executes the control instruction, thereby implementing the interaction between the user and the application. Thus, during the interaction between the user and the client, since the client can recognize the trigger operation for voice control, the user can directly trigger the input of the voice data in any area on the interaction interface without being limited to a specific voice input interface. Therefore, the user does not need to perform related operations to switch the display interface of the terminal from the interaction interface to the voice input interface. For example, the user does not need to perform the operation of exiting the display window and the operation of finding the control of the voice control service, thereby reducing the operations that the user needs to perform, improving the efficiency of the interaction between the user and the client, and also improving the user experience.

Taking an operation of maximizing the display window as an example, the user can directly click the display window. Terminal determines that the user wants to interact with the display window when recognizing the operation of clicking the display window from the display window. Then the user can directly enter voice data of “maximize the display window” on the interaction interface, so that the terminal maximizes the display window running in the background based on the voice data. It can be seen that the user does not need to exit the current display window, the user can directly perform the trigger operation that triggers voice control on the current interaction interface, which reduces the operations that the user needs to perform and improves the efficiency of the interaction between the user and the display window.

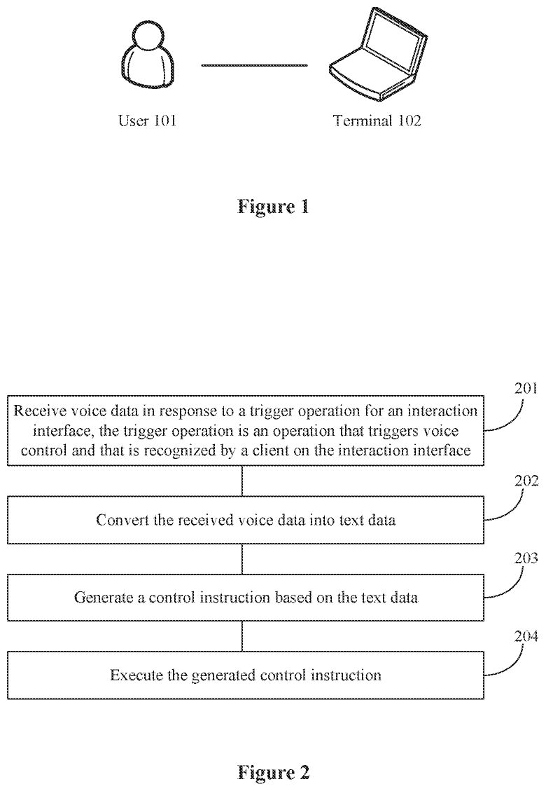

As an example, the voice control method according to the embodiments of the disclosure may be applied in the application scenario shown in FIG. 1. In this scenario, when the user 101 needs to perform voice interaction with the client on the terminal 102, the user 101 may perform a trigger operation for the interaction interface on the terminal 102, and the trigger operation is recognized by the client on the terminal 102 and is determined to be an operation that triggers voice control. The terminal 102 receives the voice data inputted by the user 101 in response to the trigger operation, and converts the voice data into text data. Then, the terminal 102 generates a corresponding control instruction based on the text data, and executes the control instruction, to implement the interaction between the client on the terminal 102 and the user 101.

Apparently, the above scenario is only exemplary illustration, and is not intended to limit the scenarios of the embodiments of the disclosure. In addition to the above exemplary scenario, the embodiments of the disclosure may also be applied to other applicable scenarios.

In order to make those skilled in the art to better understand the technical solutions in the disclosure, the technical solution according to the embodiments of the disclosure are described clearly and completely as follows in conjunction with the accompany drawings in the embodiments of the disclosure. It is apparent that the described embodiments are only a part of the embodiments according to the disclosure, rather than all the embodiments of the disclosure. All the other embodiments obtained by those skilled in the art based on the embodiments in the disclosure without any creative work belong to the scope of protection of the disclosure.

Reference is made to FIG. 2, which is a schematic flowchart of a voice control method according to some embodiments of the disclosure. The method includes steps S201 to S204.

In step S201, voice data is received in response to a trigger operation for an interaction interface. The trigger operation is an operation that triggers voice control and that is recognized by a client on the interaction interface.

As an exemplary embodiment, when the user needs to interact with the client on the terminal, the user may perform a trigger operation on the interaction interface of the terminal. For example the trigger operation may be long pressing a specific area on the interaction interface, etc. The trigger operation indicates that the user needs to interact with the client through voice control. Then, the client on the terminal may judge the trigger operation performed by the user. Specifically, the trigger operation may be matched with a preset trigger operation. It is determined that the trigger operation is an operation that triggers the start of voice control in a case that the trigger operation is matched with the preset trigger operation. After the client recognizes the trigger operation, the client triggers the start of a voice receiver (such as a microphone) on the terminal, to receive voice data inputted by the user.

It can be understood that, the client on the terminal can autonomously recognize the trigger operation that triggers the voice control, thereby automatically triggering the voice receiver to receive the voice data inputted by the user. Therefore, for the user, the user can directly input the voice data on the interaction interface without inputting the voice data on a specific voice input interface, so that the user does not need to perform too many operations, which improves the user experience.

It can be noted that the client interacting with the user may include not only a third-party software on the terminal, but also various applications on the terminal, such as the desktop, the display window of the terminal, and various functional programs built into the operating system. The interaction interface usually refers to a display interface of the terminal in which a client interacting with the user is displayed.

In some possible embodiments, the trigger operation performed by the user may be an operation performed by the user for the interaction interface. For example, the trigger operation may be operations of clicking, double-clicking, or long-pressing the client icon on the interaction interface performed by the user, or the like. Alternatively, the trigger operation may be operations of double-clicking, long-pressing, sliding a blank area (that is, the area where the client icon is not displayed) on the interaction interface performed by the user, or the like. It can be understood that, the form of the trigger operation may be set in advance. Any operation performed by the user on the terminal may be set as the trigger operation for triggering the voice control. However, in practice, in order to facilitate the user's use and minimize the changes to the existing operation rules, the trigger operation may be different from the operation that the user often uses on the terminal. For example, the user usually slide the touch display screen on the terminal towards the left or the right, to switch the client icon displayed on the interaction interface, however the user rarely slides the touch display screen upwards. Therefore, the user's operation of sliding the touch display screen upwards may be preset to be the trigger operation that triggers the start of the voice control.

Further, in order to improve the user experience, a voice recording pop-up window may be used to prompt the user to input the voice data. Specifically, in some embodiments, a voice recording pop-up window may be displayed to the user in response to the trigger operation for the interaction interface performed by the user. The voice recording pop-up window is used to prompt the user to perform voice input and is used to feedback a voice recording situation to the user. It can be noted that, after the voice recording pop-up window is displayed, in order to show the difference, between a case when the voice data is inputted and a case when the voice data is not inputted, to the user, a displaying form of the voice recording pop-up window when the voice data is inputted by the user is set to be different from a displaying form of the voice recording pop-up window when the voice data is not inputted by the user.

In step S202, the received voice data is converted into text data.

In practice, the terminal may be configured with a voice recognition engine. After the terminal receives, by using the voice receiver, the voice data inputted by the user, the voice recognition engine may recognize the voice data and convert the voice data into text data. For example, if the user enters voice data having voice content of “da kai weixin”, the terminal may use the voice recognition engine to convert the voice data into Chinese text “da kai weixin”, in some embodiments, “da kai weixin” is only used to describe the Chinese pronunciation of the voice data inputted by the user, and the similarities below refer to the same case.

As an exemplary specific embodiment, the terminal may convert the received voice data into initial text data through the voice recognition engine. Considering that the voice recognition engine cannot achieve 100% recognition accuracy in practice, therefore, after the initial text data is obtained, semantic analysis may be performed on the initial text data, and the initial text data may be adjusted according to the results of the semantic analysis, so that the content of the adjusted initial text data is more universal and/or more logical and is more suitable for the voice content that the user actually inputs. For example, assuming that there is a client named “ [symbol] ”, when the user enters the voice data having the voice content of “da kai yue du”, the initial text data usually recognized by the voice recognition engine is “ [symbol] ”. However, there is no client named “ [symbol] ” on the terminal. The initial text data may be adjusted to “ [symbol] ” by performing semantic analysis, so that the terminal subsequently can successfully launch the “ [symbol] ” client. The adjusted initial text data may be used as the text data converted from the voice data. In addition, semantic analysis may be performed on the adjusted initial text data, to segment the predicate and/or object in the adjusted initial text data, and an action keyword corresponding to the predicate and/or an object keyword corresponding to the object are obtained.

In some possible scenarios, the content of the text data obtained by the conversion may also be different from the content of the voice data inputted by the user. For example, if the voice content inputted by the user is “qing da kai wo de weixin”, the initial text data obtained by the voice recognition engine is “da kai wo de weixin”. After semantic analysis is performed, only the action keyword and the object keyword in the initial text data may be retained. The obtained adjusted initial text data may be “da kai weixin”, and “da kai weixin” is used as the text data converted from the voice data.

In step S203, a control instruction is generated based on the converted text data.

After the voice data is converted into text data, a corresponding control instruction may be generated based on the converted text data.

In some embodiments, following two exemplary implementation manners for generating a control instruction based on the converted text data are provided.

In an exemplary implementation manner, the text data is matched with preset instruction type text data, and the control instruction is generated based on the instruction type text data matched with the text data.

The preset instruction type text data refers to text data that is preset in the terminal and may be used to generate a control instruction. In practice, a corresponding control instruction may be generated based on specific text data. For example, the specific text data is “start social software M”, then a control instruction for starting and running the social software M is generated based on the text data. In another example, the specific text data is “play music”, then it is generated a control instruction for playing the first song in the current music list. Therefore, these specific text data may be used as the preset instruction type text data. The preset instruction type text data may be set by the technical personnel according to actual requirements.

In some embodiments, after the text data is obtained, the text data may be matched with the preset instruction type text data, it is determined whether a corresponding control instruction can be generated based on the result of the matching. In the embodiments, a non-limiting example of matching the text data with instruction type text data is provided. Specifically, in a matching example, the text data converted from the voice data includes an action keyword and an object keyword, the terminal may match the action keyword in the text data with action keywords in the instruction type text data, and determine an action keyword in the instruction type text data, matched with the action keyword in the text data, as a first action keyword, in addition, the terminal may match the object keyword in the text data with object keywords in the instruction type text data, and determine an object keyword in the instruction type text data, matched with the object keyword in the text data, as a first object keyword. The control instruction is generated based on the first action keyword and the first object keyword.

It can be noted that the reason why the action keyword and the object keyword in the text data need to be matched with the instructional type text data is that not all text data obtained based on the voice data inputted by the user is suitable for directly being used to generate the control instruction. It can be understood that, for the same control instruction, different users may input different pieces of voice data, and thus pieces of text data obtained by conversion may also be different. Therefore, it is necessary to match the action keyword and the object keyword in the converted text data with the instruction type text data, to determine an execution action and an execution object of the control instruction. In this way, even if different users input different pieces of voice data, different users may implement the same interaction with the client.

For example, the content of the voice data inputted by a user A is “launch social software M”, the content of the voice data inputted by a user B is “run social application M”, and the content of the voice data inputted by a user C is “start social client M”, it can be seen that, although the pieces of voice data inputted by users A, B, and C are different, the pieces of voice data are all for the terminal to run the social client M, therefore the pieces of voice data all correspond to the same control instruction for running the social client M. By matching the voice data with the action keywords in the instruction type text data, the action keywords “launch”, “run”, and “start” belonging to users A, B, and C respectively may be successfully matched with the action keyword “run” in the instruction type text data; and the object keywords “social software M”, “social application M”, and “social client M” belonging to users A, B, and C respectively may be successfully matched with the object keyword “social client M” in the instruction type text data. Therefore, the control instructions corresponding to users A, B, and C are all the control instruction for running the social client M, so that users A, B. and C can perform the same interaction with the client.

In some practical scenarios, the text data obtained based on the voice data inputted by the user may not include the object keyword. In this case, the object keyword may be determined according to an operation object on which the trigger operation is performed by the user. Therefore, in another matching example, the text data converted from the voice data includes an action keyword, the terminal may match the action keyword in the text data with action keywords in the preset instruction type text data, and determine an action keyword in the preset instruction type text data, matched with the action keyword in the text data, as a second action keyword; and the terminal may determine a second object keyword according to an operation object on which the trigger operation is performed by the user. Then the control instruction is generated based on the second action keyword and the second object keyword. In some embodiments, it is considered that the user may perform a trigger operation for the client icon on the interaction interface, and the operation object, on which the trigger operation is performed, is usually the client that the user needs to interact with. Therefore, the second object keyword may be determined according to an operation object on which the trigger operation is performed.

For example, the user may double-click the icon of the social software M on the interaction interface and input the voice data having voice content of “launch”. It can be understood that the interaction desired by the user is to launch social client M. Then, the terminal may match the action keyword “launch” in the text data with the action keywords in the instruction type text data, and determines that the action keyword “launch” is successfully matched with the second action keyword “run”. In addition, the second object keyword “social software M” is determined based on the operation object “the icon of the social software M” on which the user's double-click operation is performed. Then a control instruction for running the social software M may be generated based on the second action keyword and the second object keyword.

In other practical scenarios, the text data obtained based on the voice data inputted by the user may not include the action keyword, the action keyword may be determined according to the object keyword in the text data. Therefore, in another matching example, the text data converted from the voice data includes an object keyword, the terminal may match the object keyword in the text data with object keywords in the preset instruction type text data, and determine an object keyword in the preset instruction type text data, matched with the object keyword in the text data, as a third object keyword; and the terminal may determine a third action keyword according to the third object keyword. Then the control instruction is generated based on the third action keyword and the third object keyword. In some embodiments, considering that in some scenarios, when the user interacts with the client, the operation required to be performed by the client is usually only one operation, or the operation has the highest applicability, in this case, the terminal may determine the operation that needs to be performed on the client, i.e., the third action keyword for generating the control instruction, according to the client (i.e., the third object keyword).

For example, if social client M on the terminal is not running, and the user inputs voice data having voice content of “social client M”, it is generally considered that the user needs the terminal to run the social client M, that is, the operation needs to be performed on the social client M is usually the operation of running the social client M. In this case, the terminal may determine the third action keyword as “run” according to the third object keyword “social client M”, and then generate a control instruction for running the social client M based on the third object keyword and the third action key word.

In the above implementation manner, the action keyword and the object keyword for generating the control instruction are determined based on the matching between the text data and the preset instruction type text data. In another implementation manner, the action keyword and the object keyword for generating the control instruction are determined by performing semantic analysis on the text data.

Specifically, in the other exemplary implementation manner, semantic analysis is performed on the text data, and a fourth action keyword is determined form the text data with a certain rule; a client with which the user needs to interact, i.e., a fourth object keyword, is determined according to an operation object on which the trigger operation is performed; and the control instruction is generated based on the fourth action keyword and the fourth object keyword.

For example, the user may double-click a blank area (that is, the area where the client icon is not displayed) on the interaction interface, and input the voice data having voice content of “too bright”. The terminal may know from the semantic analysis that the user expects to reduce the brightness, that is, the action keyword is to reduce the brightness. Further, the terminal may determine that the user needs to reduce the brightness of the display screen according to the user's double-click operation on the blank area of the interaction interface, that is, the object keyword is the display screen. Then a control instruction for reducing the brightness of the display screen may be generated according to the determined action keyword and object keyword.

Apparently, the above-mentioned implementation manners are only for illustrative purposes and are not intended to limit the embodiments. In fact, in addition to the above-mentioned implementation manners, there are many other implementation manners for generating the control instruction based on the text data. For example, the terminal may directly determine the action keyword and the object keyword according to the voice data inputted by the user, or the terminal may determine what kind of control instruction need to be generated based on a matching manner between sentences.

In step S204, the generated control instruction is executed.

In some embodiments, the terminal may send the generated control instruction to the corresponding application program, so that the application program executes the control instruction. For example, if the generated control instruction is a control instruction for launching Bluetooth, increasing the brightness of the display screen, or the like, the terminal may send the control instruction to the application program for system setting to execute the control instruction. If the generated control instruction is a control instruction for decompressing files, copying files, or the like, the terminal may send the control instruction to a file manager for execution. If the generated control instruction is a control instruction for maximizing or minimizing the display window, the terminal may send the control instruction to a window manager for execution.

In some embodiments, the trigger operation recognized by the client triggers the reception of the voice data, so that operations required to be performed by the user are reduced, thereby improving the efficiency of the interaction between the user and the client. Specifically, when the user needs to interact with the client on the terminal through voice control, the terminal may receive the voice data in response to the trigger operation for the interaction interface, where the trigger operation is an operation that triggers voice control and that is recognized by a client on the interaction interface. Then the terminal may convert the received voice data into text data, and generate the control instruction for operating the application based on the text data, and the terminal executes the control instruction, thereby implementing the interaction between the user and the application. It can be seen that during the interaction between the user and the client, since the client can recognize the trigger operation for voice control, the user can directly trigger the input of the voice data in any area on the interaction interface without being limited to a specific voice input interface. Therefore, the user does not need to perform related operations to switch the display interface of the terminal from the interaction interface to the voice input interface. Thus, the user does not need to perform the operation of exiting the display window and the operation of finding the control of the voice control service, thereby reducing the operations that the user needs to perform, improving the efficiency of the interaction between the user and the client, and also improving the user experience.

In some embodiments of the present application, a voice control method is provided according to an embodiment of the disclosure. The voice control method includes: receiving voice data in response to a trigger operation for an interaction interface; determining an action keyword based on the voice data; determining an object keyword based on the operation object of the trigger operation; generating a control instruction based on the action keyword and the object keyword, wherein the control instruction is used for controlling an operation object indicated by the object keyword.

In embodiments of the present application, it can be implemented that the voice data input by the user is received in the interaction interface, by receiving voice data in response to a trigger operation for an interactive interface. Further, determining an action keyword based on the received voice data may determine an action that the user wants to perform. In addition, an object that the user wants to operate may be determined, by determining an object keyword based on an operation object of the trigger operation. Further, combining voice data input by a user with a trigger operation executed by the user, a control instruction may be generated, by generating the control instruction based on the action keyword and the object keyword. Thus, the flexibility of generating the control instruction is improved. In practice, the control instruction is used to control the object indicated by the object keyword. Thus, the control of the object that the user wants to operate is realized, by combining the voice data input by the user and the executed trigger operation.

In some embodiments, in the process of voice interaction, the interaction interface does not need to be switched to the voice input interface. Therefore, the efficiency of the user to perform voice interaction can be improved.

In some embodiments, the determining an action keyword based on the voice data comprises: converting the voice data into text data; and determining the action keyword based on the text data.

In some embodiments, the determining the action keyword based on the text data comprises: matching the text data with preset instruction type text data; and determining the action keyword based on a matching result.

In some embodiments, the determining the action keyword based on the text data comprises: determining the action keyword by performing semantic analysis on the text data.

In some embodiments, the generating a control instruction based on the action keyword and the object keyword comprises: matching the action keywords in the text data with action keywords in preset instruction type text data to determine a second motion keyword, wherein the second action keyword refers to an action keyword matched in the preset instruction type text data; determining a second object keyword according to the operation object on which the trigger operation is performed; generating the control instruction based on the second motion keyword and the second object keyword.

In some embodiments, the converting the voice data into text data comprises: converting the voice data into initial text data; adjusting the initial text data by performing semantic analysis on the initial text data, and taking the adjusted initial text data as the text data.

In some embodiments, the voice control method further includes: displaying a voice recording pop-up window; wherein a displaying form of the voice recording pop-up window when the voice data is received is different from a displaying form of the voice recording pop-up window when the voice data is not received.

In some embodiments, the voice control method further includes: executing the control instruction.

A voice control method is provided according to an embodiment of the disclosure. The voice control method includes: receiving voice data in response to a trigger operation for an interactive interface; determining an object keyword based on the voice data; determining an action keyword based on the object keyword; generating a control instruction based on the action keyword and the object keyword, wherein the control instruction is used to control an operation object indicated by the object keyword.

In some embodiments, the determining the object keyword based on the text data comprises: converting the voice data into text data; and determining the object keyword based on the text data.

In some embodiments, the determining the object keyword based on the text data comprises: matching the text data with preset instruction type text data; and determining the object keyword based on a matching result.

In some embodiments, the generating a control instruction based on the action keyword and the object keyword comprises: matching the object keyword in the text data with an object keyword in preset instruction type text data to determine a third object keyword; wherein the third object keyword refers to an object keyword matched in the preset instruction type text data; determining a third action keyword according to the third object keyword; generating the control instruction, based on the third action keyword and the third object keyword.

In some embodiments, the converting the voice data into text data comprises: converting the voice data into initial text data; adjusting the initial text data by performing semantic analysis on the initial text data, and taking the adjusted initial text data as the text data.

In some embodiments, the voice control method includes: displaying a voice recording pop-up window; wherein a displaying form of the voice recording pop-up window when the voice data is received is different from a displaying form of the voice recording pop-up window when the voice data is not received.

In some embodiments, the voice control method includes: executing the control instruction.

In some embodiments of the present application, a voice control method is provided according to an embodiment of the disclosure. The voice control method includes: receiving voice data in response to a trigger operation for an interaction interface, the trigger operation being an operation that triggers voice control and that is recognized by a client on the interaction interface; converting the voice data into text data; generating a control instruction based on the text data; and executing the control instruction.

In some embodiments, the converting the voice data into text data comprises: converting the voice data into initial text data; and adjusting the initial text data by performing semantic analysis on the initial text data, taking the adjusted initial text data as the text data.

In some embodiments, the generating a control instruction based on the text data comprises: matching the text data with preset instruction type text data, and generating the control instruction based on the instruction type text data matched with the text data.

In some embodiments, the voice control method further comprising: determining an action keyword and/or an object keyword in the adjusted initial text data by performing semantic analysis on the initial text data; wherein the generating a control instruction based on the text data comprises: generating the control instruction based on the action keyword and/or the object keyword.

In some embodiments, the text data comprises an action keyword and an object keyword, the matching the text data with preset instruction type text data, and generating the control instruction based on the instruction type text data matched with the text data comprises: matching the action keyword in the text data with action keywords in the preset instruction type text data, and determining an action keyword in the preset instruction type text data, matched with the action keyword in the text data, as a first action keyword; matching the object keyword in the text data with object keywords in the preset instruction type text data, and determining an object keyword in the preset instruction type text data, matched with the object keyword in the text data, as a first object keyword; and generating the control instruction based on the first action keyword and the first object keyword.

In some embodiments, the text data comprises an action keyword, the matching the text data with preset instruction type text data, and generating the control instruction based on the instruction type text data matched with the text data comprises: matching the action keyword in the text data with action keywords in the preset instruction type text data, and determining an action keyword in the preset instruction type text data, matched with the action keyword in the text data, as a second action keyword; determining a second object keyword according to an operation object on which the trigger operation is performed; and generating the control instruction based on the second action keyword and the second object keyword.

In some embodiments, the text data comprises an object keyword, the matching the text data with preset instruction type text data, and generating the control instruction based on the instruction type text data matched with the text data comprises: matching the object keyword in the text data with object keywords in the preset instruction type text data, and determining an object keyword in the preset instruction type text data, matched with the object keyword in the text data, as a third object keyword; determining a third action keyword according to the third object keyword; and generating the control instruction based on the third action keyword and the third object keyword.

In some embodiments, the generating a control instruction based on the text data comprises: determining a fourth action keyword by performing semantic analysis on the text data determining a fourth object keyword according to an operation object on which the trigger operation is performed; and generating the control instruction based on the fourth action keyword and the fourth object keyword.

In some embodiments, the voice control method further includes: displaying a voice recording pop-up window; wherein a displaying form of the voice recording pop-up window when the voice data is received is different from a displaying form of the voice recording pop-up window when the voice data is not received.

In some embodiments, the determining a third action keyword according to the third object keyword comprises: determining an action keyword, with the highest applicability to the third object keyword, as the third action keyword.

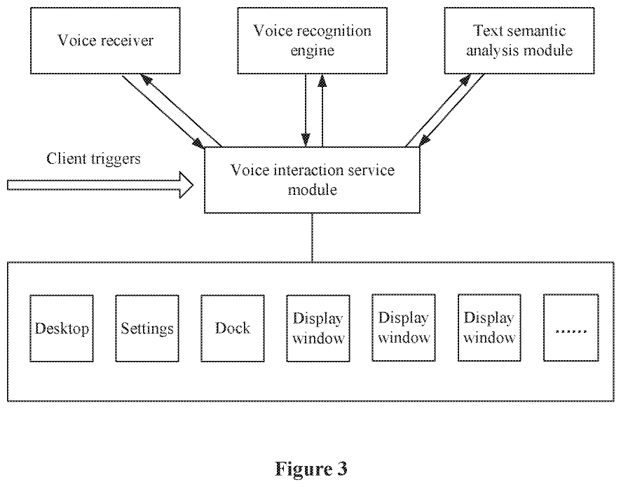

In order to introduce the technical solutions of the disclosure in more detail, the embodiments of the disclosure are described in conjunction with a specific software architecture as follows. Reference is made to FIG. 3, which is a schematic diagram of an exemplary software architecture in which the voice control method is applied according to some embodiments of the disclosure. In some scenarios, the software architecture may be applied to a terminal.

The software architecture may include a voice interaction service module, a voice receiver, a voice recognition engine, a text semantic analysis module, and various clients that may be created in the system. The client may include not only a third-party software on the terminal, but also various applications on the terminal, such as the desktop, system settings, the dock, the display window of the terminal, and various functional programs built into the operating system.

The voice interaction service module may establish a communication connection with the voice receiver, the voice recognition engine, the text semantic analysis module, and various clients, so that the voice receiver, the voice recognition engine, and the text semantic analysis module independent with each other are connected, and corresponding data is forwarded to each client to form a callback and control.

When the user needs to interact with the client through voice control, the user may perform a trigger operation for the interaction interface on the interaction interface of the terminal, and the client recognizes the trigger operation. After the client recognizes the trigger operation, the client may notify the voice interaction service module through the system interface. The voice interaction service module may start the voice receiver by sending a startup instruction. The voice receiver may start to receive voice data inputted by the user and send the voice data to the voice interaction service module. The interaction interface usually refers to a display interface of the terminal in which a client interacting with the user is displayed.

Then, the voice interaction service module sends the received voice data to the voice recognition engine. The voice recognition engine recognizes the voice data and converts the voice data into initial text data. After obtaining the initial text data, the voice recognition engine sends the initial text data to the voice interaction service module.

Considering that the voice recognition engine cannot achieve 100% recognition accuracy, the voice interaction service module may send the text data to the text semantic analysis module, and the text semantic analysis module performs semantic analysis on the initial text data, and the initial text data may be adjusted according to the results of the semantic analysis, so that the content of the adjusted initial text data is more universal and/or more logical. In addition, the text semantic analysis module may also analyze the adjusted initial text data, segment the predicate and/or object in the adjusted initial text data, to obtain an action keyword corresponding to the predicate and/or an object keyword corresponding to the object. Then, the text semantic analysis module may send the resulting text data (that is, the adjusted initial text data) to the voice interaction service module.

After receiving the text data, the voice interaction service module may match an action keyword and/or an object keyword in the text data with action keywords and object keywords in the instruction type text data, and generate a control instruction based on the instruction type text data matched with the action keyword and/or object keyword in the text data. The preset instruction type text data refers to text data that is preset in the terminal and may be used to generate a control instruction.

Specifically, in an example, the voice interaction service module may match the action keyword in the text data with action keywords in the preset instruction type text data, and determine an action keyword in the preset instruction type text data, matched with the action keyword in the text data, as a first action keyword. In addition, the voice interaction service module may match the object keyword in the text data with object keywords in the preset instruction type text data, and determine an object keyword in the preset instruction type text data, matched with the object keyword in the text data, as a first object keyword. Then, the control instruction is generated based on the first action keyword and the first object keyword.

Apparently, there are multiple implementation manners for generating a control instruction based on the received text data by the voice interaction service module. For the detailed description, the related description in the above embodiments may be referred to, which is not described herein again.

After generating the control instruction, the voice interaction service module may send the control instruction to the corresponding application program, so that the application program executes an operation corresponding to the control instruction on the client. For example, if the generated control instruction is a control instruction for launching Bluetooth, increasing the brightness of the display screen, or the like, the voice interaction service module may send the control instruction to the application program for system setting to execute the control instruction. If the generated control instruction is a control instruction for decompressing files, copying files, or the like, the terminal may send the control instruction to a file manager for execution. If the generated control instruction is a control instruction for maximizing or minimizing the display window, the terminal may send the control instruction to a window manager for execution.

It can be seen that during the interaction between the user and the client, since the client can recognize the trigger operation for voice control, the user can directly trigger the input of the voice data in any area on the interaction interface without being limited to a specific voice input interface. Therefore, the user does not need to perform related operations to switch the display interface of the terminal from the interaction interface to the voice input interface. Thus, the user does not need to perform the operation of exiting the display window and the operation of finding the control of the voice control service, thereby reducing the operations that the user needs to perform, improving the efficiency of the interaction between the user and the client, and also improving the user experience.

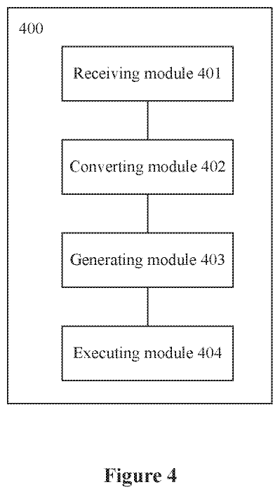

In addition, a voice control device is provided according to some embodiments of the disclosure. Referring to FIG. 4, which shows a schematic structural diagram of a voice control device according to some embodiments of the disclosure. The device 400 includes a receiving module 401, a converting module 402, a generating module 403 and an executing module 404.

The receiving module 401 is configured to receive voice data in response to a trigger operation for an interaction interface. The trigger operation is an operation that triggers voice control and that is recognized by a client on the interaction interface.

The converting module 402 is configured to convert the voice data into text data.

The generating module 403 is configured to generate a control instruction based on the text data.

The executing module 404 is configured to execute the control instruction.

In some possible embodiments, the converting module 402 includes a converting unit and an adjusting unit.

The converting unit is configured to convert the voice data into initial text data.

The adjusting unit is configured to adjust the initial text data by performing semantic analysis on the initial text data, and take the adjusted initial text data as the text data.

In some possible embodiments, the generating module 403 is further configured to: match the text data with preset instruction type text data, and generate the control instruction based on the instruction type text data matched with the text data.

In some possible embodiments, the device 400 further includes a determining module configured to determine an action keyword and/or an object keyword in the adjusted initial text data by performing semantic analysis on the initial text data. The generating module is further configured to generate the control instruction based on the action keyword and/or the object keyword.

In some possible embodiments, the text data includes an action keyword and an object keyword, and the generating module 403 includes a first matching unit, a second matching unit and a first generating unit.

The first matching unit is configured to match the action keyword in the text data with action keywords in the preset instruction type text data, and determine an action keyword in the preset instruction type text data, matched with the action keyword in the text data, as a first action keyword.

The second matching unit is configured to match the object keyword in the text data with object keywords in the preset instruction type text data, and determine an object keyword in the preset instruction type text data, matched with the object keyword in the text data, as a first object keyword.

The first generating unit is configured to generate the control instruction based on the first action keyword and the first object keyword.

In some possible embodiments, the text data includes an action keyword, and the generating module 403 includes a third matching unit, a first determining unit and a second generating unit.

The third matching unit is configured to match the action keyword in the text data with action keywords in the preset instruction type text data, and determine an action keyword in the preset instruction type text data, matched with the action keyword in the text data, as a second action keyword.

The first determining unit is configured to determine a second object keyword according to an operation object on which the trigger operation is performed.

The second generating unit is configured to generate the control instruction based on the second action keyword and the second object keyword.

In some possible embodiments, the text data includes an object keyword, and the generating module 403 includes a fourth matching unit, a second determining unit and a third generating unit.

The fourth matching unit is configured to match the object keyword in the text data with object keywords in the preset instruction type text data, and determine an object keyword in the preset instruction type text data, matched with the object keyword in the text data, as a third object keyword.

The second determining unit is configured to determine a third action keyword according to the third object keyword.

The third generating unit is configured to generate the control instruction based on the third action keyword and the third object keyword.

In some possible embodiments, the generating module 403 includes a third determining unit, a fourth determining unit and a fourth generating unit.

The third determining unit is configured to determine a fourth action keyword by performing semantic analysis on the text data.

The fourth determining unit is configured to determine a fourth object keyword according to an operation object on which the trigger operation is performed.

The fourth generating unit is configured to generate the control instruction based on the fourth action keyword and the fourth object keyword.

In some possible embodiments, the device 400 further includes a displaying module configured to display a voice recording pop-up window. A displaying form of the voice recording pop-up window when the voice data is received is different from a displaying form of the voice recording pop-up window when the voice data is not received.

In some embodiments of the disclosure, since the client can recognize the trigger operation for voice control, the user can directly trigger the input of the voice data in any area on the interaction interface without being limited to a specific voice input interface. Therefore, the user does not need to perform related operations to switch the display interface of the terminal from the interaction interface to the voice input interface. Thus, the user does not need to perform the operation of exiting the display window and the operation of finding the control of the voice control service, thereby reducing the operations that the user needs to perform, improving the efficiency of the interaction between the user and the client, and also improving the user experience.

In some embodiments of the present application, a voice control device is provided according embodiments of the present disclosure. The device includes: one or more processors; and a memory storing one or more programs. The one or more processors execute the one or more programs to perform operations. The operations include: receiving voice data in response to a trigger operation for an interaction interface; determining an action keyword based on the voice data; determining an object keyword based on the operation object of the trigger operation; generating a control instruction based on the action keyword and the object keyword, wherein the control instruction is used for controlling an operation object indicated by the object keyword.

In some embodiments, the one or more processors execute the one or more programs to perform operations. The operations include: converting the voice data into text data; determining the action keyword based on the text data.

In some embodiments, the one or more processors execute the one or more programs to perform operations. The operations include: matching the text data with preset instruction type text data; determining the action keyword based on a matching result.

In some embodiments, the one or more processors execute the one or more programs to perform operation. The operation includes: performing semantic analysis on the text data to determine the action keyword.

In some embodiments, the one or more processors execute the one or more programs to perform operations. The operations include: matching the action keywords in the text data with action keywords in preset instruction type text data; determining a second motion keyword; wherein the second action keyword refers to an action keyword matched in the preset instruction type text data; determining a second object keyword according to the operation object that triggers the operation; generating the control instruction based on the second motion keyword and the second object keyword.

It can be noted that the embodiments in the specification are described in a progressive manner, with the emphasis of each of the embodiments on the difference from other embodiments. For the same or similar parts between the embodiments, reference may be made one to another. Since the device disclosed in the embodiments corresponds to the method disclosed in the embodiments, the description for the system or the device is simple, and reference may be made to the method embodiments for the relevant parts.

It can be further noted that the relationship terminologies such as “first”, “second” and the like are only used herein to distinguish one entity or operation from another, rather than to necessitate or imply that the actual relationship or order exists between the entities or operations. Furthermore, terms of “include”, “comprise” or any other variants are intended to be non-exclusive. Therefore, a process, method, article or device including a plurality of elements includes not only the elements but also other elements that are not enumerated, or also include the elements inherent for the process, method, article or device. Unless expressively limited otherwise, the statement “comprising (including) a . . . ” does not exclude the case that other similar elements may exist in the process, method, article or device.

Steps of the method or the algorithm described in conjunction with the embodiments disclosed herein may be implemented directly with hardware, a software module executed by a processor or a combination thereof. The software module may be provided in a Random Access Memory (RAM), a memory, a Read Only Memory (ROM), an electrically-erasable ROM, an electrically erasable programmable ROM, a register, a hard disk, a removable disk, a CD-ROM, or a storage medium in any other forms known in the art.

The above description of the embodiments enables those skilled in the art to implement or use the present disclosure. Multiple modifications to these embodiments are apparent to those skilled in the art, and the general principle defined herein may be implemented in other embodiments without deviating from the spirit or scope of the present disclosure. Therefore, the present disclosure is not limited to these embodiments described herein, and conforms to the widest scope consistent with the principle and novel features disclosed herein.

1. A voice control method, comprising:
receiving voice data in response to a trigger operation for an interaction interface;
determining an action keyword based on the voice data;
determining an object keyword based on the operation object of the trigger operation;
generating a control instruction based on the action keyword and the object keyword, wherein the control instruction is used for controlling an operation object indicated by the object keyword.

2. The method according to claim 1, wherein the determining an action keyword based on the voice data comprises:
converting the voice data into text data; and
determining the action keyword based on the text data.

3. The method according to claim 2, wherein the determining the action keyword based on the text data comprises:
matching the text data with preset instruction type text data; and determining the action keyword based on a matching result.

4. The method according to claim 2, wherein the determining the action keyword based on the text data comprises:
determining the action keyword by performing semantic analysis on the text data.

5. The method according to claim 3, wherein the generating a control instruction based on the action keyword and the object keyword comprises:
matching the action keywords in the text data with action keywords in preset instruction type text data to determine a second motion keyword; wherein the second action keyword refers to an action keyword matched in the preset instruction type text data;
determining a second object keyword according to the operation object on which the trigger operation is performed;
generating the control instruction based on the second motion keyword and the second object keyword.

6. The method according to claim 2, wherein the converting the voice data into text data comprises:
converting the voice data into initial text data:
adjusting the initial text data by performing semantic analysis on the initial text data, and
taking the adjusted initial text data as the text data.

7. The method according to claim 1, further comprising:
displaying a voice recording pop-up window; wherein
a displaying form of the voice recording pop-up window when the voice data is received is different from a displaying form of the voice recording pop-up window when the voice data is not received.

8. The method according to claim 1, further comprising:
executing the control instruction.

9. A voice control method, comprising:
receiving voice data in response to a trigger operation for an interactive interface:
determining an object keyword based on the voice data;
determining an action keyword based on the object keyword;
generating a control instruction based on the action keyword and the object keyword, wherein the control instruction is used to control an operation object indicated by the object keyword.

10. The method according to claim 9, wherein the determining an object keyword based on the voice data comprises:
converting the voice data into text data and
determining the object keyword based on the text data.

11. The method according to claim 10, wherein the determining the object keyword based on the text data comprises:
matching the text data with preset instruction type text data; and
determining the object keyword based on a matching result.

12. The method according to claim 11, wherein the generating a control instruction based on the action keyword and the object keyword comprises:
matching the object keyword in the text data with an object keyword in preset instruction type text data to determine a third object keyword; wherein the third object keyword refers to an object keyword matched in the preset instruction type text data;
determining a third action keyword according to the third object keyword;
generating the control instruction, based on the third action keyword and the third object keyword.

13. The method according to claim 10, wherein the converting the voice data into text data comprises:
converting the voice data into initial text data:
adjusting the initial text data by performing semantic analysis on the initial text data, and taking the adjusted initial text data as the text data.

14. The method according to claim 9, further comprising:
displaying a voice recording pop-up window; wherein
a displaying form of the voice recording pop-up window when the voice data is received is different from a displaying form of the voice recording pop-up window when the voice data is not received.

15. The method according to claim 9, further comprising:
executing the control instruction.

16. A voice control device, comprising:
one or more processors; and
a memory storing one or more programs,
wherein the one or more processors execute the one or more programs to perform operations of:
receiving voice data in response to a trigger operation for an interaction interface;
determining an action keyword based on the voice data;
determining an object keyword based on the operation object of the trigger operation;
generating a control instruction based on the action keyword and the object keyword, wherein the control instruction is used for controlling an object indicated by the object keyword.

17. The device according to claim 16, wherein the one or more processors execute the one or more programs to perform operations of:
converting the voice data into text data, and
determining the action keyword based on the text data.

18. The device according to claim 17, wherein the one or more processors execute the one or more programs to perform operations of:
matching the text data with preset instruction type text data, and
determining the action keyword based on a matching result.

19. The device according to claim 17, wherein the one or more processors execute the one or more programs to perform an operation of:
performing semantic analysis on the text data to determine the action keyword.

20. The device according to claim 18, wherein the one or more processors execute the one or more programs to perform operations of:
matching the action keywords in the text data with action keywords in preset instruction type text data; determining a second motion keyword; wherein the second action keyword refers to an action keyword matched in the preset instruction type text data;
determining a second object keyword according to the operation object that triggers the operation;
generating the control instruction based on the second motion keyword and the second object keyword.
